(19) United States
(12) Patent Application Publication
(10) Pub. No.: US 2010/0100514 A1
(43) Pub. Date: Apr. 22, 2010

(54) SENSOR UNIT FOR ENVIRONMENT OBSERVATION COMPRISING A NEURAL PROCESSOR

(75) Inventors: Pierre Raymond, Saint Louis (Haut-Rhin) (FR); Guy Paillet, Corte Madera, CA (US); Anne Menendez, Penngrove, CA (US)

Correspondence Address: MICHAUD-Kinney Group LLP, 306 INDUSTRIAL PARK ROAD, SUITE 206, MIDDLETOWN, CT, 06457, US

(73) Assignee: Deutsch-Franzosisches Forschungsinstitut Saint- Louis, Saint Louis (Haut-Rhin) (FR)

(21) Appl. No.: 12/260,511

(22) Filed: Oct. 29, 2008

(30) Foreign Application Priority Data
Oct. 20, 2008 (DE) 10 2008 052 160.4

(51) Int. Cl. G06N 3/02

(52) U.S. Cl. 706/20

(57) ABSTRACT

A sensor unit comprising a sensor, a neural processor and a communication device, wherein the sensor unit is adapted to perform pattern recognition by means of the neural processor and to transfer the result of the pattern recognition via the communication device.

### CROSS REFERENCE TO RELATED APPLICATION

This application claims priority to German Patent Application No. 10 2008 052 160.4 filed on Oct. 20, 2008, the subject matter of this patent document is incorporated by reference herein in its entirety.

### FIELD OF THE INVENTION

The present invention concerns a sensor unit and a method for environment observation as well as a sensor network composed of sensor units.

### BACKGROUND OF THE INVENTION

There is vast number of ranges of application requiring the observation of the environment. For example, this applies for weather phenomenons, seismic activity, motion detection, shape recognition, acoustic or electromagnetic signatures, analyses of environmental pollution as well as observation of pack-ice or of sensible locations. For example, the observation may serve to military or civilian purposes. Here it is desirable to form a respective sensor unit as small as possible, especially if a plurality of sensor units is to be provided in order to be able to observe a larger spatial area. One possibility consists in communicating the output signals of the sensor with a central computer in which the evaluation of the sensor signals is performed. However, a large bandwidth is necessary for transmitting the sensor data from the sensor device to the central computer.

### SUMMARY OF THE INVENTION

Therefore it is the object of the present invention to provide a sensor device which does not exhibit the above mentioned disadvantages and which above all merely necessitates a small bandwidth for the connection to the central computer and which at the same time may be assembled in a simple and robust manner and can be manufactured reasonably.

This object is achieved by a sensor unit according to claim 1. Claim 15 relates to a method for environment observation. Advantageous embodiments may be taken from the dependent claims.

The sensor unit according to the invention comprises a sensor, a neural processor and a communication device. Here the sensor unit is arranged to perform pattern recognition by means of the neural processor and to transmit the result of the pattern recognition via the communication device. Thus, a decision is made locally within the sensor unit. Therefore the sensor unit is an autonomous apparatus.

In contrast to conventional processor structures a neural processor which is preferably adapted to be capable of learning, is able to perform pattern recognition of any complexity always in the same time period independently from the number of the existing neurons, due to its associative memory structure. Based on artificial intelligence the highly non-linear classification of a pattern is performed as a context-sensitive decision. With this technology the sensor unit is able to recognize certain situations for which it has specifically been trained for and to react correspondingly. For example, this is made possible by using highly integrated neural network components.

For example, the result of pattern recognition is a class in which the pattern comes under an identification of a concrete pattern. One advantage of a neural processor is that the rules of the pattern recognition may be modified without necessitating an adaptation of at least one of material and logic (i.e. hardware and/or software) of the processor. The recognition may be adapted anytime by importing a new database either locally or remotely. One possibility consists in cloning the knowledge, for example the whole database or parts of the database, i.e. to transfer them to another sensor unit.

A considerable reduction both of the required data bandwidth and of the energy consumption results from the fact that reduced information assessed as relevant only locally is transmitted. On the other hand, known sensor units most of the time transmit irrelevant data. The energy consumption may be further lowered if parts of the sensor unit, for instance the communication device, are waked up, i.e. turned on or retrieved from an energy saving mode, only upon the occurrence of an external event.

The sensor unit may optionally receive data via the communication device. Examples for such data are new training data for the neural processor, the database (as a whole or partially) or instructions for the senor unit, for example for the use of the result of pattern recognition.

Depending on the fact which kind of pattern is to be detected the sensor may be for example an optical, acoustic, seismic, thermal, multispectral, electromagnetic or chemical sensor. For example, an optical sensor is a CCD or CMOS camera. A sensor unit having on optical sensor is also designated as a miniature visual event detector (MVED). For example, an acoustic sensor is a microphone. For example, a seismic sensor is an acceleration sensor. The number and the kind of sensors as well as of the neural processors may be adapted to the kind of application of the sensor unit.

For example, if the sensor unit has to be employed to detect the presence of an object and to classify this object, then, for example, the sensor may be a camera. In the context of pattern recognition it is determined, whether the image of the camera contains an object and whether a person, a vehicle or an airplane is concerned. In a detailed pattern recognition, for example, it may be determined which type of vehicle (automobile, motorcycle, bus or truck) or airplane is concerned, up to the specific model. In the case of a human being pattern recognition up to the identification of a certain person is possible.

If, as it is intended by the invention, only the result of the pattern recognition is transmitted the amount of the data to be transmitted and thus the necessary bandwidth is extremely small. For example, the result is the class in which the pattern comes under, an exact identification of the pattern or the presence of an anomaly. Thus, a selective transmission based on a local discrimination of results is provided. The communication device, for example, is a GSM module, a UMTS module, a module for another mobile communications standard, a Bluetooth module or an infrared module or any other standard radio module. By using standardized communication paths there is no specific license required to operate the sensor unit. Here the sensor unit preferably comprises an antenna tuned to the communication device. In one embodiment of the invention the sensor unit is adapted such that the result of the pattern recognition is only transmitted if a pattern was recognized.

The pattern may be, for example, a movement pattern which is recognized in a sequence of images or in a sequence of signals. It is possible to provide a plurality of sensors for different kinds of patterns in one sensor unit, for example, an optical and an acoustic sensor. The output data of the sensors are processed simultaneously or sequentially by the same neural processor or simultaneously by a plurality of neural processors, for example, a network of neural processors. One such sensor unit is also designated as a “multiexpert device”.

Preferably, the sensor unit comprises a localization device for determining the position of the sensor unit. In this way an automatic localization is made possible. For example, the localization device may be a GPS module (Global Positioning System). Optionally, the time may be determined by the localization device, too. The position of the sensor unit and optionally the time are preferably transmitted via the communication device together with the result of the pattern recognition. Thus, also the site of the occurrence of the pattern is known.

Still preferably, the sensor unit comprises a device for detecting the orientation of the sensor unit. For example, this device may be a compass. In this way a still more exact localization of the recognized pattern is possible. The information on the orientation of the sensor unit is transmitted together with the result of the pattern recognition and optionally with the position of the sensor unit via the communication device.

The localization device and/or the device for determining the orientation of the sensor unit may be separate devices or a constituent of the communication device.

In one embodiment of the invention the sensor unit comprises a housing which is formed in the manner of a roly-poly. This means that the sensor unit automatically adopts a defined position independently from the position in which the sensor unit was put down or dropped. For example, the housing has a hemispherical part and a conical part, wherein in particular the base circle of the conical part matches with the circular area of the hemispherical part. The centre of gravity of the sensor unit within the housing is positioned such that the sensor unit gets up automatically. For example, the centre of gravity is located on the symmetry axis of the conical part of the housing and as close as possible to the hemispherical shell. In the conical part of the housing, for example, antennas or acoustic interfaces may be arranged.

A battery, for example a lithium battery or a fuel cell, serves to supply the sensor unit with energy. Optionally at least one solar cell is provided by which the battery may be charged. In this way the time period during which the sensor unit may be operated autonomously increases significantly.

In one embodiment of the invention the housing of the sensor unit is formed at least partially transparent. In this way it is possible to arrange components like an optical sensor or a solar cell in a protected area within the housing without interfering with the functionality of the component.

Preferably, the components of the sensor unit, in particular the electric and electronic components are arranged in three dimensions, for example on a plurality of levels. The arrangement of the components on a plurality of levels results in a structure having the form of a rectangular parallelepiped or of a cylinder. In this way an especially compact shape of the sensor unit is achieved. The three dimensional arrangement leads to the fact that the sensor unit resists even high physical demands, for example strong forces acting on the sensor unit.

Preferably, at least some of the components of the sensor unit are wired in three dimensions. A connection of the components is established, for example, by means of a sidewall of the rectangular parallelepiped or of the cylinder. Another possibility is the connection by means of the MID technology (molded interconnected device) in which the electric connection cables are incorporated into an injection-molded part. Thus, the MID part establishes both a mechanical and an electric connection between a plurality of components.

In one embodiment of the invention the sensor unit comprises a plurality of sensors, wherein each sensor covers one zone of the sensor unit's detection area divided into zones. Thus, for example, the sensor unit allows an allround-view detection. From the sensor the output signal of which contains a recognized pattern may easily be concluded to the position of the recognized pattern.

The present invention further concerns a sensor network having a plurality of sensor units as described above. The sensor units preferably communicate with each other/or with a central computer. Here the sensor units are preferably networked in the form of a master/slave assembly. This means that the individual sensor units, for example, are not directly in contact with the central computer but communicate the results of the pattern recognition to the master sensor unit which as far as it is concerned subsequently forwards them to the central computer in a bundled and/or otherwise processed form. For example, the master sensor unit may perform a data consolidation, for example by means of a neural processor, i.e. an expert, in order to send the consolidated data to the central computer subsequently. Advantageously the individual sensor units of the sensor network are distributed and aligned such that their sensors are directed to the scene to be inspected.

During environment observation the environment is detected by means of a sensor, the pattern recognition is performed by means of a neural processor and the result of the pattern recognition is communicated via a communication device.

### BRIEF DESCRIPTION OF THE DRAWINGS

The present invention is now explained in more detail based on an exemplary embodiment thereof. In the drawings:

FIG. 1 shows a system overview of a sensor unit,

FIG. 2 shows a structure of a sensor unit,

FIG. 3a, 3b show a sensor unit having four sensors,

FIG. 4 shows a possible internal structure of a component,

FIG. 5 shows a connection of a plurality of components,

FIG. 6 shows an arrangement of components in the shape of a rectangular parallelepiped,

FIG. 7 shows a cylindrical shape,

FIG. 8 shows a further shape of a rectangular parallelepiped,

FIG. 9 shows a housing of the kind of a roly-poly,

FIG. 10 shows a network of sensor units and

FIG. 11 shows a two-dimensional neural decision space.

### DETAILED DESCRIPTION OF THE PREFERRED EMBODIMENTS

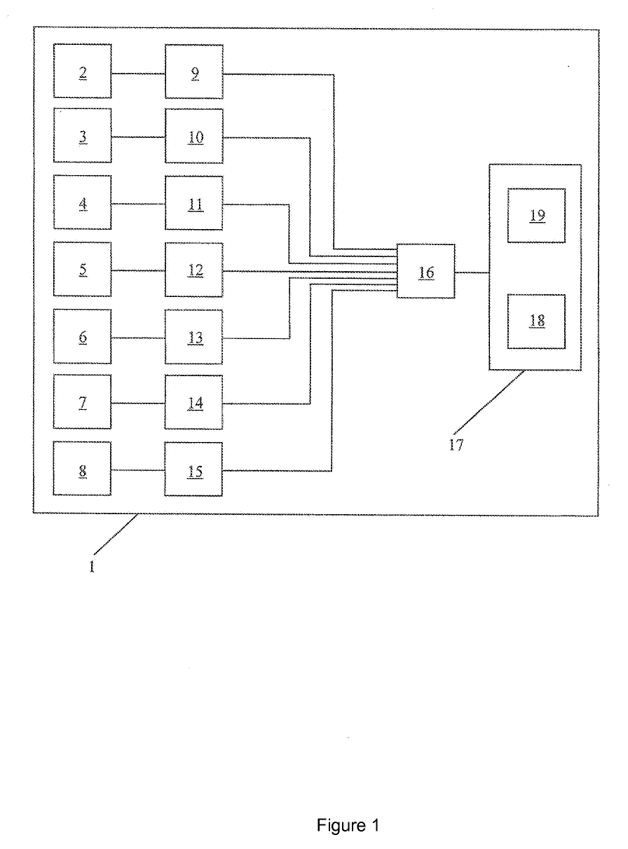

In FIG. 1 a schematic block diagram of a sensor unit 1 is shown. The sensor unit 1 comprises seven sensors 2 to 8 each of which is connected to one of the neural processors 9 to 15. The neural processors 9 to 15 are connected with a further optional neural processor 16 which in turn is connected to a communication device 17. The communication device 17 comprises a GSM module 18 and a GPS module 19. Instead of a neural processor 16 also a conventional microprocessor, for example a logic component like a FPGA, may be used.

Each of the sensors 2 to 8 may be an optical (in the visual, infrared or ultraviolet spectral region), acoustic, seismic, thermal, multispectral, electromagnetic, chemical or any other sensor. Each of the sensors 2 to 8 may detect the whole surroundings of the sensor unit 1 or a part thereof. The number of the sensors and of the neural processors of the sensor unit may be adapted to the requirements and thus, may deviate from the number 7 mentioned above. For example, the neural processors 9 to 16 are based on a silicon structure having a highly parallel architecture.

Each of the neural processors 9 to 15 obtains the output signal of the sensor 2 to 8 with which it is associated and performs a specific pattern recognition. The results are communicated to the neural processor 16 which bundles and, if necessary, further processes them. The result of the activity of the neural processor 16 is transferred to the communication device 17, for example assisted by an electronic interface or by a classical processor without neural structures (not shown in the figures). The communication device 17 communicates the result by means of the GSM module 18. The GPS module 19 detects the position of the sensor unit 1 which is also transferred by the GSM module 18. The processor 16 may be omitted. In this case the activity of the processor 16 is carried out by one or more of the processors 9 to 15 which perform the pattern recognition, alternatively each of the processors 9 to 15 are connected to the communication device 17.

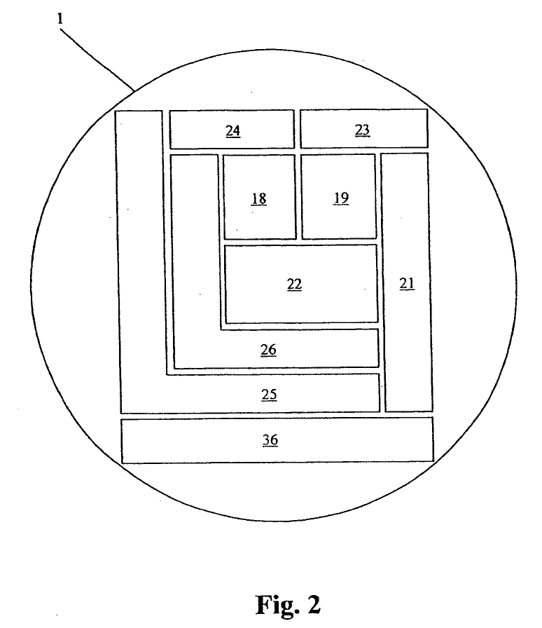

FIG. 2 shows a further diagrammatic representation of the sensor unit 1, wherein the arrangement of the individual components approximately corresponds to the vertical physical distribution of the components. In the lower-most part of the housing of the sensor unit 1 a ballast 36 is provided which in connection with the shape of the housing as described later leads to a defined position of the sensor unit 1. The GPS module 19 is arranged near the GPS antenna 23 and the GSM module 18 is arranged near the GSM antenna 24. Block 21 representing the sensors 2 to 8 is in contact with block 22 which not only contains the neural processors 9 to 16 but also an electronic interface. Block 26 represents an energy storage and block 25 designates solar cells by means of which the energy storage 26 is charged.

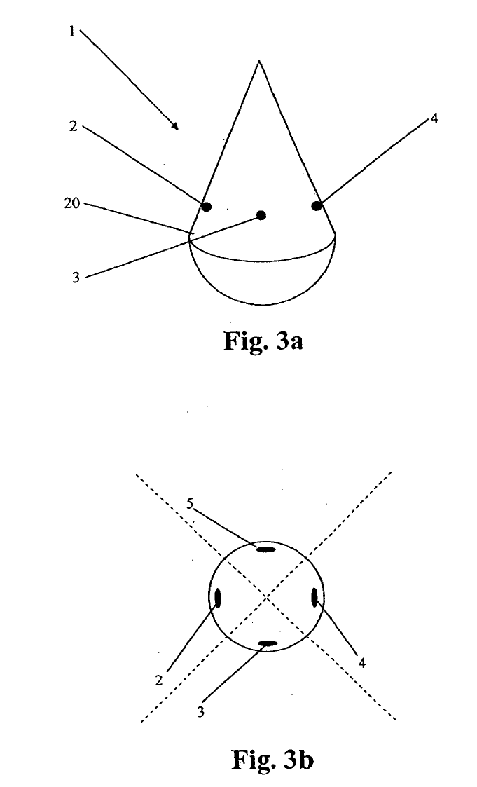

FIG. 3a shows an exemplary division of the detection area of a sensor unit 1 having four sensors 2 to 5 into four zones. Sensor 2 is associated with a first zone, sensor 3 is associated with a second zone, sensor 4 is associated with a third zone and sensor 5, not shown, is associated with a fourth zone. The sensors 2, 3, 4 and 5 are arranged in the housing 20 such that they entirely detect the respective zone with which they are associated. In the plan view shown in FIG. 3b of the three dimensional representation of FIG. 3a the division of the detection area into four zones may be recognized very well. Here the broken lines represent the stripes of the zones. Optionally each zone may be observed by more than one sensor.

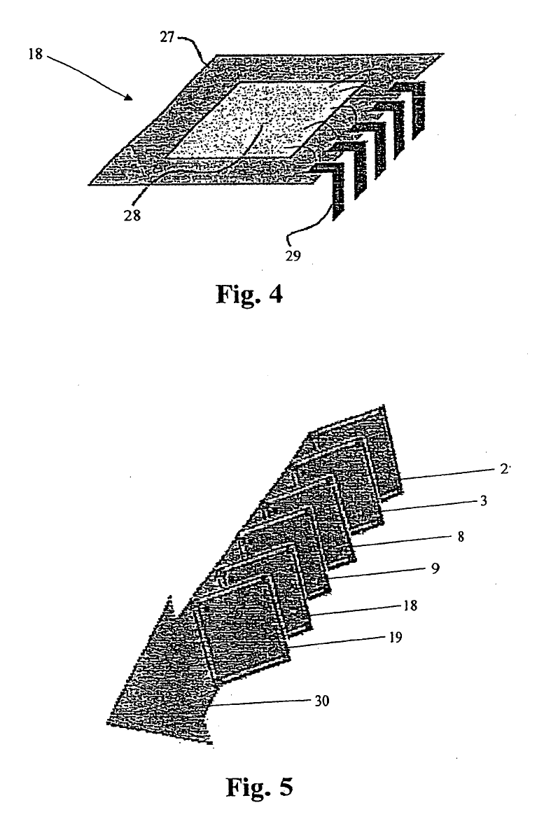

In FIG. 4 a component of the sensor unit 1 is represented by the exemplary GSM module 18. The component comprises a support 27 on which a functional area 28 is arranged immediately. The functional area 28 is connected with electric terminals 29. Since the component 18 is not encapsulated in an own housing it may be formed especially small and may be integrated in a space-saving manner into the sensor unit. The other components like the sensors 2 to 8, the neural processors 9 to 16 and the GPS module 19 are preferably composed in a similar manner.

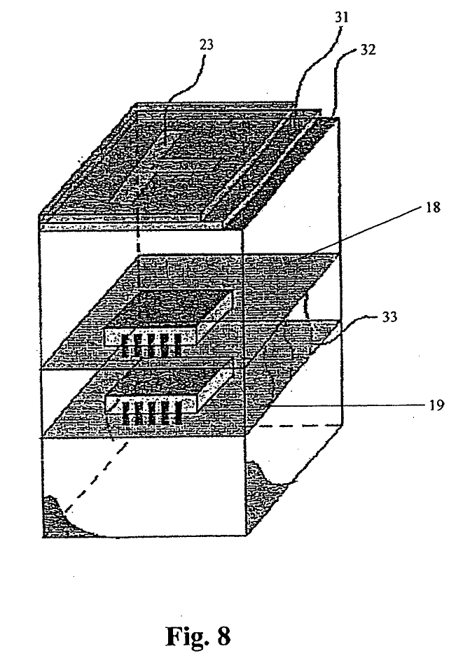

As it may be observed from FIG. 5 the components of the sensor unit 1, here, for example, the sensors 2 and 3, the neural processors 8 and 9, the GSM module 18 and the GPS module 19, are stacked one over the other and are interconnected by a bus 30. The connection of a component with the bus 30 is performed via the terminals 29. Preferably, the components only comprise their functional areas which are arranged in three dimensions and are interconnected. In this way, a space-saving and insensitive structure is achieved. Alternatively, the individual components additionally comprise a respective housing and, for example, are arranged on a two dimensional printed circuit board (as shown in FIG. 8).

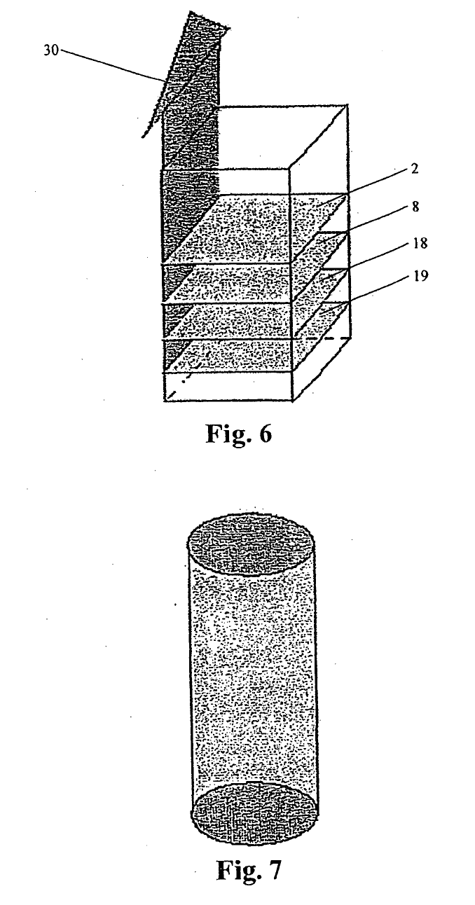

FIG. 6 shows an exemplary layered arrangement of the components, here, for example, of the sensor 2, the neural processor 8, the GSM module 18 and the GPS module 19, leading to the shape of a rectangular parallelepiped of the block of components. On one sidewall of the rectangular parallelepiped the bus 30 is arranged through which the components are connected with each other.

FIG. 7 shows a cylindrical shape of the stack of components in an exemplary way.

FIG. 8 shows a more detailed representation of the components stacked in the form of a rectangular parallelepiped. On the top surface of the rectangular parallelepiped there is, for example, located the GSM antenna 23 which is separated from a ground layer 23 by a dielectric layer 31. Thereunder there are represented, for example, a level comprising the GSM module 18 and a level comprising the GPS module 19. The different components are interconnected by lines 33 which are arranged on the sidewalls of the rectangular parallelepiped. The spaces between the components are filled with an epoxy resin resulting in a high mechanical resistance of the sensor unit 1 against shocks, for example. For example, such shocks occur when the sensor unit 1 is shot or dropped, for example from an airplane, and impacts on the ground or on the water.

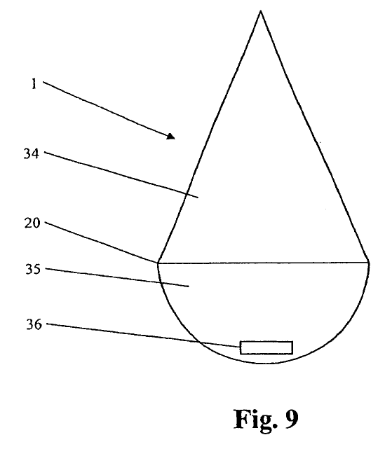

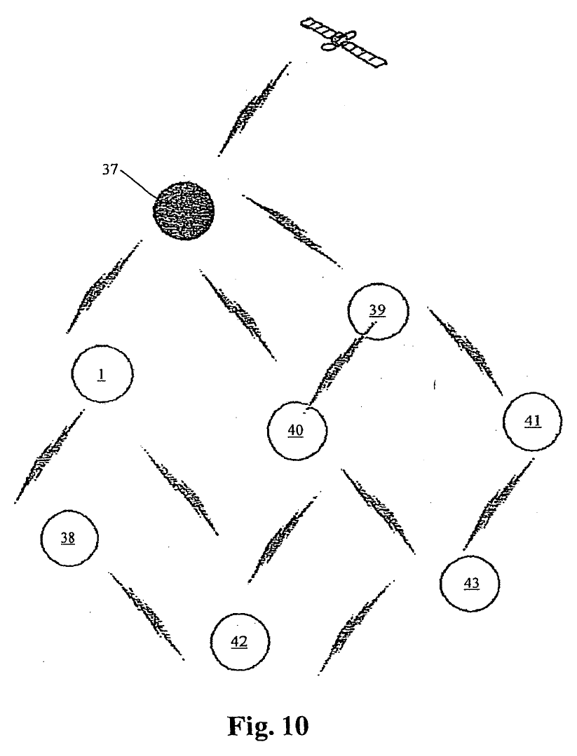

FIG. 9 shows a diagrammatic lateral view of the housing 20 of the sensor unit 1. The housing 20 consists of a hemispherical part 35 and of a conical part 34. The base circle of the conical part 34 is coincident with the cutting circle of the hemispherical part 35. Thus, the whole housing 20 is rotationally symmetrical. The ballast 36 is arranged on the symmetry axis of the housing 20 on the boundary of the hemispherical part 35. Based both on the shape of the housing 20 and on the low centre of gravity due to the ballast 36 and to the distribution of loads of the components of the sensor unit 1 the housing 20 automatically gets up into a position in which its symmetry axis is directed to the centre of earth. Here the conical part 34 automatically faces to the sky and the hemispherical part 35 faces to the earth. Thus it is assured that, for example, the solar cell 25 faces to the sky and the sensors 2 to 8 cover the desired area around and/or above the sensor unit 1. Alternatively, each other shape of the housing is possible which leads—optionally by use of ballast—to the automatic alignment of the sensor unit.

FIG. 10 shows a sensor network of eight sensor units 1 and 37 to 43 which are networked with each other in the form of a master/slave assembly. The sensor unit 37 represents the master while the sensor units 1 and 38 to 43 constitute the slaves. In addition, the sensor unit 1 preferably contains a communication device, not shown, for example a Bluetooth module or a WiFi module. The sensor units 37 to 43 are preferably structured substantially identical with the sensor unit 1. Alternatively, different sensor units may be structured or set up differently and thus may be appropriated especially to recognize different patterns or kinds of patterns, but nevertheless they communicate data. Depending on the case of the application the sensor network may comprise more or less than eight sensor units.

The sensors of the sensor units 1 and 38 to 43 observe the environment and subsequently their output signals of the pattern recognition are forwarded within the respective sensor unit to the respective neural processor. The sensor units 1 and 38 to 43 communicate the results of the pattern recognition, for example via Bluetooth, to the sensor unit 37. The collected and optionally additionally processed results of the sensor units 1 and 38 to 43 are forwarded by the sensor unit 37 via GSM to a central computer, not shown. Since the communication of the sensor units 1 and 38 to 43 with the sensor unit 37 via Bluetooth is performed only over a short distance, further saving of energy is possible. Alternatively, other transmission technologies as for example WiFi or ZiGBee are possible. In case of failure of the sensor unit 37, another one of the sensor units 1 and 38 to 43 adopts the role of the master.

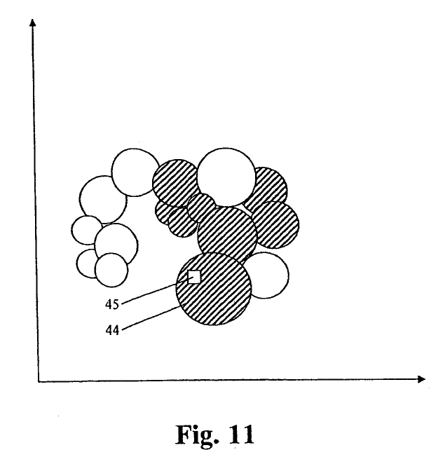

The pattern recognition of a neural processor is explained in more detail with the help of FIG. 11. A neuron is a reactive memory capable of detecting the distance of an input vector to a reference vector stored therein. If the distance lies within the sphere of influence of the neuron, then the neuron outputs an identification value, namely the class. An approach for implementation is RBF (Radial Basis Function) in which a category and a sphere of influence are allocated to a reference vector, namely the prototype, in an N dimensional space. Here a plurality of prototypes may be assigned to the same category and the spheres of influence may be partially overlapped. A neural processor for performing the present invention is, for example, of the type CogniMem of the General Vision Company.

FIG. 11 shows in an exemplary way a two dimensional decision space in which, for example, one dimension corresponds to the form and the other dimension corresponds to the colour of the object to be recognized. Here, sixteen prototypes are represented in an exemplary way, wherein each prototype is associated with one of two classes a or b. The spheres of influence of the prototype which are associated with class a are represented without filling and the spheres of influence of the prototypes associated with category b are represented by hatches. In a neural processor the decision space may consist in more than two dimensions, for example up to N=256 dimensions. A prototype comprises as many coefficients as the decision space has dimensions.

The process of classification consists in determining whether an N dimensional input vector is located in the sphere of influence of one of the prototypes. This is realized by calculating the distance between the input vector and each prototype and by comparing it with the sphere of influence of the respective prototype.

There are three possibilities for the result of the comparison. In the case of an absolute recognition the input vector lies in the sphere of influence of one or more prototypes of the same class. The input vector is associated with this class. In the case of a partial recognition the input vector lies in the spheres of influence of at least two prototypes of different classes. In this case the input vector is considered as being recognized, but not as being identified. If the input vector does not lie in the observation area of any prototype it is considered as not being recognized.

The process of learning of the neural processor consists in presenting a series of patterns, i.e. vectors of a known class, to the neural network. Within the scope of the learning procedure the spheres of influence of the prototypes are adapted automatically. For each newly presented input vector either no change of the neural network or the adaptation of the sphere of influence of one or more prototypes or the creation of a new prototype and also of a new neuron is performed.

In the example represented in FIG. 11 the input vector 45 for the pattern recognition represented as a small box is presented to the trained neural processor. This vector lies in the sphere of influence of the prototype 44 with which class b is associated. The pattern belonging to the input vector 45 is thus considered as coming under class b.

The advantage of a neural processor is, besides its fast pattern recognition, its capability for generalization. This means that the processor may recognize the pattern even if it was not trained exactly with this pattern. Moreover, a neural processor is able to consolidate information. Due to artificial intelligence on the chip the neural network may define its internal architecture automatically and is able to react within some microseconds. The sensor unit has the capability to download and to divide knowledge as well as to learn during operation.

What is claimed is:

1. A sensor unit comprising a sensor, a neural processor and a communication device, wherein the sensor unit is adapted to perform pattern recognition by means of the neural processor and to transfer the result of the pattern recognition via the communication device.

2. The sensor unit according to claim 1, further comprising a localization device for determining the position of the sensor unit.

3. The sensor unit according to claim 1, wherein the sensor unit is adapted to transfer the result of the pattern recognition only if the pattern was recognized.

4. The sensor unit according to claim 1, further comprising a device for detecting the orientation of the sensor unit.

5. The sensor unit according to claim 1, wherein the sensor unit comprises a housing which is shaped in the manner of a roly-poly.

6. The sensor unit according to claim 1, further comprising at least one solar cell.

7. The sensor unit according to claim 1, wherein components of the sensor unit are arranged in three dimensions, for example on a plurality of levels.

8. The sensor unit according to claim 1, further comprising a three dimensional wiring of at least some of the components of the sensor unit.

9. The sensor unit according to claim 1, wherein at least some components of the sensor unit are arranged in the shape of a rectangular parallelepiped or of a cylinder.

10. The sensor unit according to claim 9, wherein at least some of the components of the sensor unit are connected with each other by means of a sidewall of the rectangular parallelepiped or of the cylinder.

11. The sensor unit according to claim 1, wherein at least some components of the sensor unit are connected with each other by means of the MID technology.

12. The sensor unit according to claim 1, further comprising a plurality of sensors, wherein each sensor covers one zone of the sensor unit's observation area which is divided into zones.

13. A sensor network comprising a plurality of sensor units according to claim 1.

14. The sensor network according to claim 13, wherein the sensor units are networked with each other in the form of a master/slave assembly.

15. A method for environment observation, comprising the steps of detecting the environment by means of a sensor, performing pattern recognition by means of a neural processor and transferring the result of the pattern recognition via a communication device.
